(19) United States
(12) Patent Application Publication
(10) Pub. No.: US 2026/0296118 A1
(43) Pub. Date: Oct. 1, 2026

(54) WHEEL SUSPENSION FOR A MOTOR VEHICLE

(71) Applicants: BAYERISCHE MOTOREN WERKE AKTIENGESELLSCHAFT, München (DE); MUHR UND BENDER KG, Attendorn (DE)

(72) Inventors: Ludwig SEETHALER, Erdweg (DE); Jurij JECMENJAK-URBAN, Garching bei Müchen (DE); Michael ALFES, Lennestadt (DE); Sascha PICUR, Wenden (DE); Stefano ROSTA, Haiger (DE); Jochen ASBECK, Attendorn (DE)

(21) Appl. No.: 19/489,804

(22) PCT Filed: Jun. 26, 2024
(86) PCT No.: PCT/EP2024/067881

§ 371 Date: Dec. 3, 2025

(30) Foreign Application Priority Data
Jun. 26, 2023 (DE) 10 2023 116 694.8

(51) Int. Cl. B60G 5/03

(52) U.S. Cl. CPC B60G 5/03; B60G 2200/20; B60G 2202/114; B60G 2204/121; B60G 2204/4302; B60G 2206/7101

(57) ABSTRACT

The invention relates to a wheel suspension for a motor vehicle, comprising: a spring link; at least one fastening device which has two fastening elements which each have a respective abutment surface between which the spring link is arranged and connected in a force-fitting manner to the fastening device; at least one holding device which has two holding parts which each have a respective support surface between which the spring link is arranged and connected in a force-fitting manner to the holding device via the support surfaces, wherein the first fastening element has a receiving opening and the second fastening element has a connection part which is arranged in the receiving opening to form a form-fitting connection, and/or the holding parts are designed separately from one another and at least the support surface of one of the holding parts is connected in a form-fitting manner to the spring link.

The invention relates to a wheel suspension for a motor vehicle according to the preamble of claim 1.

DE 10 2020 128 606 A1 discloses a device for mounting a transverse leaf spring of a vehicle on a vehicle structure. The device comprises a lower clamping shell, which is arranged on a lower side of the transverse leaf spring viewed in vehicle vertical direction in the installed state in the vehicle, and an upper clamping shell, which is arranged on an upper side of the transverse leaf spring viewed in vehicle vertical direction in the installed state in the vehicle. The lower and the upper clamping shell each include a support surface, which is respectively formed such that the transverse leaf spring can be at least partially clamped between the two support surfaces in the mounted state. Further, the lower and the upper clamping shell each include two connection areas, at which the two clamping shells are connected to each other in force-fitting manner.

It is the object of the invention to provide a wheel suspension for a motor vehicle such that a mechanical load capacity of the wheel suspension can be particularly increased.

According to the invention, this object is solved by a wheel suspension for a motor vehicle with the features of claim 1. Advantageous configurations of the invention are the subject matter of the dependent claims and of the description.

The invention relates to a wheel suspension for a motor vehicle, which is for example formed as a passenger car or as a utility motor vehicle. Preferably, the motor vehicle, in particular in its completely produced state, comprises the wheel suspension.

The wheel suspension comprises at least one spring link provided or formed for guiding at least one vehicle wheel of the motor vehicle, which is formed as a leaf spring element. In other words, the at least one vehicle wheel can be guided by means of the spring link. The spring link can therefore be understood to mean, in particular, a wheel link. The leaf spring element can be understood to mean, in particular, a leaf spring. In that the spring link is formed as a leaf spring element, a wheel guiding leaf spring can in particular be understood by the spring link.

Preferably, a main extension direction of the spring link at least substantially extends in vehicle transverse direction of the motor vehicle, in particular in installation position of the wheel suspension in the motor vehicle. Therefore, a transverse leaf spring can in particular be understood by the leaf spring. The spring link or the leaf spring is preferably, in particular at least partially, predominantly or completely, formed of a fiber composite material. Therefore, the spring link can in particular be referred to as fiber composite leaf spring, in particular as a fiber composite transverse leaf spring.

In particular, a ground contact element of the motor vehicle can be understood by the vehicle wheel. Preferably, the motor vehicle, in particular a structure of the motor vehicle, can be supported or is supported on a ground, in particular a roadway, via the vehicle wheel. In particular, the vehicle wheel rolls on the ground or the roadway during a drive of the motor vehicle.

The wheel suspension comprises at least one fastening device formed separately from the spring link, which comprises at least two fastening elements formed separately from each other and in particular connected to each other. In other words, the fastening device is formed multi-part, in particular two-part. Thus, the fastening device comprises at least one first fastening element and at least one second fastening element in particular formed separately from the first fastening element. The fastening elements each comprise a respective abutment surface. This means that the first fastening element comprises at least one first abutment surface and that the second fastening element comprises at least one second abutment surface in particular different from the first abutment surface, preferably spaced from the first abutment surface. The spring link is, in particular at least indirectly or directly, arranged between the abutment surfaces. Put in other words, the first fastening element, in particular the first abutment surface, is arranged on a first side of the spring link and the second fastening element, in particular the second abutment surface, is arranged on a second side of the spring link different from the first side, in particular opposing the first side.

For example, the first side, in particular in installation position of the wheel suspension in the motor vehicle, is a top side of the spring link facing upwards in vehicle vertical direction of the motor vehicle. For example, the second side, in particular in installation position of the wheel suspension in the motor vehicle, is a bottom side of the wheel link facing downwards. Thus, the first fastening element, in particular the first abutment surface, is for example at least partially, in particular predominantly or completely, arranged above the spring link in vehicle vertical direction, and the second fastening element, in particular the second abutment surface, is for example at least partially, in particular predominantly or completely, arranged below the spring link in vehicle vertical direction. Alternatively, it is of course possible that the first side is formed as a bottom side of the spring link facing downwards, in particular in installation position of the wheel suspension in the motor vehicle, and the second side is formed as a top side of the spring link facing upwards, in particular in installation position of the wheel suspension in the motor vehicle. Thus, the first fastening element, in particular the first abutment surface, can be at least partially, in particular predominantly or completely, arranged below the spring link in vehicle vertical direction, and the second fastening device, in particular the second abutment surface, can be at least partially, in particular predominantly or completely, arranged above the spring link in vehicle vertical direction. Preferably, the spring link is for example at least indirectly or directly supported on the fastening elements, in particular on the abutment surfaces, in particular in vehicle vertical direction of the motor vehicle.

The spring link is, for example at least indirectly or directly, connected to the fastening device, in particular to the fastening elements, via the abutment surfaces at least in force-fitting manner. This means that the spring link is, in particular at least indirectly or directly, connected to the first fastening element via the first abutment surface in force-fitting manner and is, in particular at least indirectly or directly, connected to the second fastening element via the second abutment surface in force-fitting manner. Put in other words, the spring link, in particular at least a connection area of the spring link, is clamped or fixed between the fastening elements, in particular between the abutment surfaces. Therefore, clamping elements can in particular be understood by the fastening elements. In particular, a friction-fitting connection can be understood by the force-fitting connection. By the fact that the spring link is connected to the fastening device via the abutment surfaces in force-fitting manner, it can in particular be understood that the connection of the spring link by means of the fastening device, in particular via the abutment surfaces, is at least partially effected by a force fit.

The fastening device, in particular the first and/or the second fastening element, is for example formed of a, in particular respective, metal. Thus, the fastening elements are for example metallic clamping parts.

The fastening device, in particular the first fastening element and/or the second fastening element, comprises at least one first bearing location, via which the spring link, in particular via the fastening device, can be or is, in particular at least indirectly or directly, coupled to the structure of the motor vehicle in articulated manner. In other words, the spring link is, in particular at least indirectly or directly, connected or connectable to the structure of the motor vehicle via the first bearing location in articulated manner. This means that the fastening device, and in particular the spring link, is or can be, in particular at least indirectly or directly, fastened to the structure of the motor vehicle via the first bearing location. By the articulated coupling of the spring link to the structure, it can in particular be understood that the spring link coupled to the structure via the first bearing location or the fastening device coupled to the structure via the bearing location is pivotable about at least one pivot axis in relation to the structure. For example, the first bearing location is formed as a rubber bearing or a rubber bearing is arranged at the first bearing location.

For example, a body-in-white of the motor vehicle can be understood by the structure. Preferably, the structure is formed as a, in particular self-supporting, body of the motor vehicle. For example, the structure at least partially, in particular completely, delimits an interior space of the motor vehicle. In particular, the interior space can be referred to as vehicle interior space or as a passenger compartment. In particular if the structure is formed as a, in particular self-supporting, body, a chassis of the motor vehicle is for example a part of the body. Therein, the chassis is for example a part of a floor assembly or a floor element of the body. The chassis is for example formed as a carrier, in particular as an axle carrier. The carrier is for example formed frame-shaped. This means that the carrier is for example formed as a frame. Thus, coupling of the spring link to the chassis and/or the body of the motor vehicle via the first bearing location can in particular be understood by coupling of the spring link to the structure via the first bearing location.

The wheel suspension comprises at least one holding device formed separately from the spring link and the fastening device, and in particular spaced from the fastening device, which comprises at least two holding parts. In other words, the holding device comprises at least one first holding part and at least one second holding part, in particular different from the first holding part. The holding parts each comprise a respective support surface. This means that the first holding part comprises at least one first support surface and that the second holding part comprises at least one second support surface, in particular different from the first support surface. The spring link is, in particular at least indirectly or directly, arranged between the support surfaces. In other words, the first holding part, in particular the first support surface, is arranged on the first side of the spring link and the second holding part, in particular the second support surface, is arranged on the second side of the spring link. Thus, the first holding part, in particular the first support surface, is for example at least partially, in particular predominantly or completely, arranged above the spring link in vehicle vertical direction, and the second holding part, in particular the second support surface, is at least partially, in particular predominantly or completely, arranged below the spring link for example in vehicle vertical direction. Alternatively, the first holding part, in particular the first support surface, is at least partially, in particular predominantly or completely, arranged below the spring link, for example in vehicle vertical direction, and the second holding part, in particular the second support surface, is at least partially, in particular predominantly or completely, arranged above the spring link, for example in vehicle vertical direction. Preferably, the spring link is supported on the holding parts, in particular via the support surfaces, in vehicle vertical direction.

The spring link is, in particular at least indirectly or directly, connected to the holding device in force-fitting manner, in particular to the holding parts, via the support surfaces at least in force-fitting manner. Put in other words, the spring link, in particular a fastening area of the spring link different from the connection area, is clamped or fixed between the holding parts and in particular between the support surfaces. Therefore, a respective clamping part can in particular be understood by the respective holding part. For example, the holding device, in particular the first holding part and/or the second holding part, is at least partially, in particular predominantly or completely, formed of a, in particular respective, metal.

The holding device, in particular the first and/or the second holding part, comprises at least one second bearing location, via which the spring link can be or is, for example at least indirectly or directly, coupled to the vehicle wheel, in particular to a wheel carrier for the vehicle wheel, in articulated manner, in particular via the holding device. In other words, the spring link is, in particular at least indirectly or directly, connected or connectable to the vehicle wheel or the wheel carrier in articulated manner via the second bearing location. This means that the wheel carrier and in particular the vehicle wheel is or can be, in particular at least indirectly or directly, fastened to the fastening device and in particular to the spring link via the second bearing location. By coupling the spring link to the vehicle wheel in articulated manner, it can in particular be understood that the vehicle wheel coupled to the spring link via the second bearing location, in particular via the fastening device, is pivotable about at least one pivot axis in relation to the spring link and in particular in relation to the fastening device. This means that an articulated connection to the wheel carrier and in particular to the vehicle wheel can be presented via the second bearing location. The second bearing location is for example formed as a rubber bearing or a rubber bearing is arranged at the second bearing location.

In order to be able to particularly increase a mechanical load capacity of the wheel suspension, it is provided according to the invention that the first fastening element comprises at least one receiving opening and the second fastening element comprises at least one connection part different from a screw element, which is, in particular at least partially, predominantly or completely, arranged in the receiving opening for forming or for effecting a form-fitting connection between the fastening elements. In other words, the connection part is at least partially arranged in the receiving opening to form or effect the form-fitting connection between the fastening elements. Again in other words, the fastening elements are, in particular directly, connected to each other in form-fitting manner via the connection part arranged or received in the receiving opening while bypassing the spring link. Thus, the receiving opening is formed for arranging or receiving the connection part. Preferably, the receiving opening and the connection part are formed corresponding to each other. Preferably, the connection part is spaced from the abutment surfaces. By the fact that the connection part is different from a screw element, it can in particular be understood that the connection part is not formed as a screw element. In particular, the connection part is free of a thread, this means that the connection part does not comprise a thread. In particular, the receiving opening is free of a thread, this means that the receiving opening does not comprise a thread. In other words, the form-fitting connection is not a screw connection.

In order to be able to particularly increase the mechanical load capacity of the wheel suspension, it is alternatively or additionally provided according to the invention that the holding parts are formed separately from each other. This means that the holding device is formed multi-part, in particular two-part. At least the support surface of one of the holding parts is, in particular at least indirectly or directly, connected to the spring link in form-fitting manner. This means that the first support surface of the first holding part and/or the second support surface of the second holding part is, in particular at least indirectly or directly, connected to the spring link in form-fitting manner. In other words, at least the support surface of one of the holding parts forms a, in particular direct, form fit with the spring link. Again in other words, at least the support surface of one of the holding parts is at least partially formed as a coupling area, in particular different from a screw element, via which the holding part comprising the coupling area, is, in particular directly, connected to the spring link in form-fitting manner. In particular, a coupling surface can be understood by the coupling area, which is preferably formed corresponding to the fastening area of the spring link. Preferably, the form-fitting connection between the spring link and the at least one of the holding parts via the support surface thereof is not a screw connection. This means that this form-fitting connection is not formed as a screw connection.

In order to be able to particularly increase the mechanical load capacity of the wheel suspension, it is alternatively or additionally provided according to the invention that at least one of the respective fastening elements, in particular the respective first and/or the respective second fastening element, comprises at least one respective receiving area, in which a respective receiving element of the leaf spring element is received or arranged, whereby the leaf spring element and the respective fastening element, in particular the respective first and/or the respective second fastening element, are, for example at least indirectly or directly, connected to each other in form-fitting manner. In other words, the respective receiving element of the leaf spring element is arranged or received in the respective receiving area for forming a form-fitting connection or while forming a form-fitting connection. This means that the leaf spring element forms an at least indirect, in particular direct, form fit with at least one of the fastening elements, in particular with the respective first and/or with the respective second fastening element, in particular at least via one of the respective abutment surfaces, preferably via the respective first and/or the respective second abutment surface. This form-fitting connection is preferably not a screw connection. This means that the respective receiving element and/or the respective receiving area is not a screw element. Thus, the respective receiving element and/or the respective receiving area is free of a thread.

For example, an opening, in particular a recess, can be understood by the respective receiving area. The respective receiving element is for example formed as an elevation. Preferably, the respective receiving element and the respective receiving area are formed corresponding to each other.

In particular, the following realizations and considerations underlie the invention: Principally, it is conceivable to integrally design the holding device, which receives the spring link and in particular at least one rubber bearing. Therein, it is principally conceivable to not provide a form fit between the holding device and the spring link, wherein such a form fit either would not be readily presentable due to the integral design of the holding device. Further, it is principally conceivable to design the fastening elements of the fastening parts as a shell construction. Force introduction parts in the form of the integral holding device and/or the shell-shaped fastening elements can for example present an efficient solution for manageable operating loads as they can occur in vehicles of the compact class. However, limits can be set for forces transferable or to be transferred, in particular due to an elasticity of the shell construction. In particularly heavy vehicles such as for example SUVs, very significant, that is particularly great, forces can occur in particular in special events like potholes or in case of misuse. Usually, a mounting of the integral fastening device cannot be feasible in practice-oriented manner, for example due to a three-dimensional arrangement of multiple rubber bearings in the space, which can be installed inclined in two views. Similarly, a target conflict between sufficient clearance between the integral clamping parts and the spring link for effortless joining of the components before screwing and deformation of the holding parts can arise if the screws are tightened. This deformation can generate particularly high stresses in the notch root and therefore not allow a large joint clearance.

In contrast, the mechanical load capacity of the wheel suspension can be particularly increased by means of the wheel suspension according to the invention. This means that a stability of the wheel suspension can be particularly increased. In particular, this can be effected by the form fit of the fastening elements and/or by the form fit of at least one of the holding parts with the spring link and/or by the form fit of the respective fastening element with the spring link. Thus, in the fastening device, the form fit or the form-fitting connection of the fastening elements to each other can be provided in addition to the force fit of the fastening elements with the spring link via the abutment surfaces. Alternatively or additionally, the form fit or the form-fitting connection of at least one of the holding parts to the spring link via the support surface can be provided in addition to the force fit or the force-fitting connection of the spring link to the holding device. Alternatively or additionally, the form fit of the respective fastening element with the leaf spring element via the respective receiving element and the respective receiving area can be provided in addition to the force fit of the fastening elements with the spring link via the abutment surfaces. By the respective form fit, a respective overload protection of the wheel suspension can in particular be effected. Thus, particularly high forces can for example be particularly securely transferred from the vehicle wheel via the spring link to the structure or the body, in particular by means of a particularly suitable force introduction. This can be ensured by means of the wheel suspension according to the invention. In particular, a safety with respect to a damage or destruction of the wheel suspension can be particularly increased by means of the wheel suspension according to the invention.

In that the fastening device is formed multi-part or two-part, a stability or a mechanical load capacity of the holding device, in particular of the holding parts, can be particularly increased since bending of the holding device, in particular of the holding parts, in pre-tensioning the screws can for example be kept particularly low or can be avoided. In particular, the target conflict between the sufficient clearance between the clamping part and the spring link, in particular for effortless joining, and the deformation of the holding parts when the screws are tightened, can be avoided. Upon mounting of the holding device, the first holding part can be mounted for example from the top and the second holding part for example from the bottom on the spring link. Upon mounting, the holding parts can in particular be placed on an end side of the spring link, and screws for effecting the clamping connection of the spring element to the holding parts can subsequently be mounted and tightened. Thus, a mounting effort can be kept particularly low. This means that a production effort of the wheel suspension, in particular of the motor vehicle, can be kept particularly low.

Preferably, the fastening elements are not designed in shell construction, but for example in the form of two solid, in particular upper and lower, fastening elements or clamping parts. Thus, the respective fastening element is preferably solidly formed. For example, the respective fastening element is produced by means of casting or by means of forging. This means that the respective fastening element can be produced or formed as a cast part or forged part, in particular of steel or of aluminum. Thereby, a sufficiently high or particularly high surface pressure between the respective fastening element and the spring link is achievable. In particular, this particularly high surface pressure is suitable for the transfer of forces occurring in particularly heavy vehicles.

In further configuration, it is provided that the support surfaces at least partially, in particular predominantly or completely, delimit or form a receiving space formed as an undercut or in undercut manner. In other words, the receiving space or the undercut is at least partially, in particular predominantly or completely, covered by the support surfaces. For form-fitting connection of the spring link to at least one of the holding parts, the fastening area of the spring link is arranged in the receiving space. This means that the fastening area of the spring link is arranged in the receiving space or the undercut to connect the spring link to at least one of the holding parts in form-fitting manner, in particular in direct manner, that is to form or effect the form fit with the at least one of the holding parts. In other words, for form-fitting connection of the spring link to the first holding part via the first support surface and/or to the second holding part via the second support surface, the connection area of the spring link is arranged in the receiving space or the undercut. Thereby, the spring link can be particularly securely connected to the holding device. Thereby, the mechanical load capacity of the wheel suspension can be particularly increased. In particular, detachment of the spring link from the holding device can be particularly securely avoided.

Preferably, it is provided that the fastening area is, in particular at least partially, predominantly or completely, formed wedge-shaped. In other words, a shape or a contour of the spring link at the fastening area is wedge-shaped, that is formed as a wedge. This means that the fastening area has a wedge-shaped contour or wedge-shaped shape. In particular, by means of the wedge-shaped contour or shape, the form fit to the holding device, in particular to the first holding part and/or the second holding part, can be generated or effected. Thereby, the mechanical load capacity of the wheel suspension can be particularly increased. In particular, a safety with respect to detachment of the spring element from the holding device can be particularly increased.

In further configuration, it is provided that at least one of the holding parts comprises at least one stop area extending obliquely or perpendicularly to its support surface, on which the spring link, in particular directly, abuts. Put in other words, the spring link is supported on the holding device, in particular on the holding parts, along a first direction via the support surface and, in particular directly, supported on the holding device, in particular on the first holding part and/or the second holding part, in a second direction extending obliquely or perpendicularly to the first direction via the stop area. Thus, the first holding part for example comprises a stop area extending obliquely or perpendicularly to the first support surface and/or the second support surface, which can in particular be referred to as first stop area, wherein the spring link, in particular directly, abuts on the first stop area. For example, the second holding part comprises a stop area extending obliquely or perpendicularly to the first and/or the second support surface, which can in particular be referred to as second stop area, wherein the spring link, in particular directly, abuts on the second stop area. The stop areas in particular referred to as stops can in particular serve as a form fit in the second direction, for example in transverse direction of the spring link, in particular inwards, wherein the spring link for example abuts on the stop areas without clearance. In case of load peaks from the outside, as they in particular occur in curb impacts, a force is for example transferred via the respective stop area from the vehicle wheel, in particular via the holding device, via the respective stop areas, in particular without impairing the friction fit of the force-fitting connection to the spring link for example formed by means of screwing. By the respective stop area, the mechanical load capacity of the wheel suspension can be particularly increased.

For example, the first direction extends in vehicle vertical direction, in particular in installation position of the wheel suspension in the motor vehicle. For example, the second direction extends in vehicle transverse direction, in particular in installation position of the wheel suspension in the motor vehicle. For example, the spring link is at least substantially outwards supported in vehicle transverse direction of the motor vehicle via the respective support surface, in particular in installation position of the wheel suspension in the motor vehicle.

In further configuration, it is provided that at least one of the abutment surfaces comprises a bulge. This means that the first abutment surface of the first fastening element and/or the second abutment surface of the second fastening element comprises a respective bulge, that is formed bulged. In other words, the first abutment surface and/or the second abutment surface is spherically shaped or formed. Thereby, a uniform surface pressure between the respective fastening element, in particular the respective abutment surface, and the spring link can for example be achieved. A radius of the bulge is for example dimensioned such that several tenths of a millimeter of gap occur at the front and rear edge to the spring link in the force-free state if the respective fastening element, in particular centrally, rests. For example, the radius of the bulge is at least 1000 millimeters, in particular 2000, 4000 or 8000 millimeters. In particular, the radius is in the order of 8000 millimeters. By the bulge, the mechanical load capacity of the wheel suspension can be particularly improved.

In further configuration, it is provided that the leaf spring element or the spring link comprises at least one first leaf spring part and at least one respective second leaf spring part formed separately from the first leaf spring part. In other words, the leaf spring element or the spring link is formed multi-part, in particular three-part. Thus, the first leaf spring part and two second leaf spring parts are for example provided. Preferably, the respective receiving element is exclusively formed by the respective second leaf spring part, in particular related to the first and the respective second leaf spring part. In other words, the respective second leaf spring part is exclusively received or arranged in the respective receiving area of the respective fastening element, in particular related to the first and the respective second leaf spring part, whereby the leaf spring element or the spring link and the respective fastening element are connected to each other in form-fitting manner. This means that the form fit between the leaf spring element and the respective fastening element is for example at least indirectly, in particular directly, effected by the respective second leaf spring part, and for example is not effected by the first leaf spring part. Thereby, the form fit can be effected in particular manner and/or particularly low-effort manner. In particular, a production effort can be kept particularly low.

Preferably, it is provided that the leaf spring parts, in particular the first and the respective second leaf spring part, are formed fiber-reinforced. In other words, the leaf spring parts comprise fibers. This means that the respective leaf spring part is for example respectively formed by a respective matrix material and respective fibers, which are preferably embedded in the respective matrix material. Preferably, it is provided that the fibers of the first leaf spring part, in particular exclusively, extend in a first direction and the fibers of the respective second leaf spring part, in particular exclusively, extend in a second direction extending obliquely or perpendicularly to the first direction. In other words, the directions of the fibers of the first leaf spring part and the respective second leaf spring part are different. Thus, related to the first leaf spring part, additional fiber layers in the form of the respective second leaf spring part are for example applied to the spring link in the area of an inner clamping, wherein the additional fiber layers extend obliquely or transversely to the fibers of the first leaf spring part, for example similar to a belt. By the inner clamping, the clamping effected by means of the fastening elements can in particular be understood. The respective fibers of the respective leaf spring part are for example unidirectional fibers, which can in particular be referred to as UD fibers.

By the fiber-reinforced leaf spring parts or by the fibers extending obliquely or perpendicularly to each other, the form fit can be particularly securely effected. Further, the production effort can be kept particularly low.

For example, the first direction at least substantially extends in vehicle transverse direction of the motor vehicle, in particular in installation position of the wheel suspension in the motor vehicle. For example, the second direction at least substantially extends in vehicle longitudinal direction of the motor vehicle, in particular in installation position of the wheel suspension in the motor vehicle.

In further configuration, it is provided that the leaf spring element or the spring link comprises at least one local respective material thickening formed integrally with a base body of the leaf spring element or of the spring link. In other words, the leaf spring element and in particular the base body thereof is respectively locally thickened in the form of the respective material thickening, in particular in the respective clamping area. Preferably, the respective receiving element is at least partially, in particular completely, formed by the respective material thickening. In other words, the respective local material thickening is arranged or received in the respective receiving area, whereby the leaf spring element and the respective fastening element are, in particular at least indirectly or directly, connected to each other in form-fitting manner. The base body is for example the first leaf spring part. For example, the respective material thickening is, in particular exclusively, formed by the matrix material. This means that the respective material thickening for example comprises, in particular additional, matrix material, and can in particular be free of fibers. Thus, a local variation of a fiber volume content of the leaf spring element can for example be effected or is effected by the respective material thickening. By the respective material thickening, the form fit can be effected particularly securely and/or with particularly low effort. Further, the production effort can be kept particularly low.

By the fact that the base body and the respective local material thickening are integrally formed, it can in particular be understood that the base body and the respective material thickening are, in particular commonly, formed from one piece, for example a monobloc. This means that the base body and the respective material thickening are not formed separately from each other and are, in particular subsequently, connected to each other.

In further configuration, at least one foil provided with particles, in particular diamond particles or particles of similarly hard materials like silicon carbide or corundum, is provided, which is arranged, in particular directly, between the spring link and the fastening device, in particular the first fastening element and/or the second fastening element, and/or, in particular directly, between the spring link and the holding device, in particular the first holding part and/or the second holding part. Thus, the foil is provided with diamond particles and/or silicon carbide particles and/or corundum particles or the like. In other words, the foil is arranged between the spring link and at least a partial area of one of the abutment surfaces of the fastening device or one of the support surfaces of the holding device. In particular, the foil directly abuts on the spring link. In particular, the foil directly abuts on the holding device or the fastening device.

Thus, a foil provided with particles, which can in particular be referred to as first foil, is for example arranged between the spring link and the fastening device, in particular the first or the second fastening element. For example, the first foil directly contacts the spring link and/or the fastening device. Alternatively or additionally, at least one foil provided with particles, which can in particular be referred to as further foil, is arranged between the spring link and the holding device, in particular the first or the second holding part. For example, the further foil directly contacts the spring link and/or the holding device.

For example, a respective first foil provided with particles is respectively arranged between the spring link and the respective fastening element, in particular directly contacting the respective fastening element and/or the spring link. For example, a respective further foil provided with particles is respectively arranged between the spring link and the respective holding part, in particular directly contacting the respective holding part and/or the spring link.

Diamond particles and/or corundum particles and/or silicon carbide particles or the like can in particular be understood by the particles. The particles can press into the surfaces of both friction partners, for example under screw preload force, whereby a micro form fit can be effected, which can particularly increase an effective friction coefficient between the two friction partners. According to arrangement of the foil, the spring link and at least one of the fastening elements and/or the spring link and at least one of the holding parts can be understood by the friction partner. The particles for example have a diameter of, in particular about, 100 μm. In particular, the respective force fit can be particularly improved by means of the particles, whereby the mechanical load capacity of the wheel suspension can be particularly increased. By the fact that the, in particular respective, foil is provided with the particles, it can in particular be understood that the, in particular respective, foil comprises the particles, in particular that the particles are incorporated into the, in particular respective, foil, for example in a surface of the, in particular respective, foil.

In further configuration, it is provided that the, in particular respective, foil is or will be pressed with the fastening device, in particular with the first fastening element and/or the second fastening element, or the holding device, in particular the first holding part and/or second holding part, for example for preconditioning. Put in other words, the foil is or will be pressed at least with the partial area, in particular for preconditioning. Thus, the, in particular respective, first foil can for example be or become pressed with the respective fastening element and/or the, in particular respective, further foil can be or become pressed with the respective holding part. By pressing, the particles can be pressed into the holding device or the fastening device, the material of which is for example harder than a material of the spring link for example formed of the fiber composite material. Thereby, an exclusive or predominant incorporation of the particles in a surface of the spring link can be avoided or reduced. Thereby, the respective friction-fitting connection can be particularly improved. By pressing, it can in particular be understood that the respective foil is, in particular directly, placed on the respective fastening element or the respective fastening part and pressed with a surface pressure of for example at least 60 Megapascal to in particular ensure a sufficient or particularly good form fit and/or friction fit.

In further configuration, at least one plastic foil different from the foil is provided, which is arranged between the spring link and the fastening device and/or between the spring link and the holding device at least partially without overlap with the, in particular respective, foil. Put in other words, the at least one plastic foil is arranged between the spring link and a second partial area, different from the partial area, in particular at least indirectly or directly adjoining to the partial area, of one of the abutment surfaces or one of the support surfaces. By the fact that the plastic foil is without overlap with the foil, it can in particular be understood that an overlap of the foil and the plastic foil is or will be at least partially avoided, that means that the foil and the plastic foil are for example at least partially not arranged above each other, but next to each other.

For example, at least one respective first plastic foil is respectively arranged between the spring link and the respective fastening element without overlap with the respective foil or the respective first foil. For example, at least one respective further plastic foil is respectively arranged between the spring link and the respective holding part at least partially without overlap with the respective foil or respective further foil. The plastic foils are different from the foil provided with the particles. The plastic foil or the first and/or the further plastic foil is or are for example formed of acrylonitrile-butadiene-styrene (ABS). By means of the respective plastic foil, stress peaks at the surface of the spring link, in particular in the fiber composite material, which for example still occur despite of optimized design of respective support surfaces or abutment surfaces, can be particularly extensively distributed. In particular, the plastic foil is arranged in the area of the highest surface pressure, in particular inserted in a matrix material. Further, by particularly tough and/or particularly abrasion-resistant material of the plastic foil, wear can be particularly reduced at locations, at which relative movements between the fastening device or the holding device and the spring link occur.

Preferably, it is provided that the, in particular respective, foil at least partially extends in a, in particular respective, recess of the plastic foil. In other words, the, in particular respective, foil is at least partially arranged in the, in particular respective, recess of the plastic foil. For example, the respective first foil at least partially extends in a recess of the respective first plastic foil. For example, the respective second foil at least partially extends in a recess of the respective second plastic foil. In particular, a material recess can be understood by the recess. Thereby, a respective friction coefficient can be, in particular locally, increased by means of the respective foil, and wear can be, in particular locally, particularly minimized by means of the plastic foil in the recess or in the area of the recess.

In further configuration, it is provided that at least one bearing device is arranged at the first bearing location, via which the spring link can be coupled or is coupled to the structure, in particular the body and/or the chassis, of the motor vehicle in articulated manner, in particular via the fastening device. In other words, the second bearing location is formed as the bearing device. The bearing device is for example a rubber bearing.

For example, it is provided that at least one foil provided with particles, in particular diamond particles and/or silicon carbide particles and/or corundum particles, is arranged between the bearing device and the fastening device, in particular the first and/or the second fastening element, which can in particular be referred to as intermediate foil. In other words, the bearing device adjoins on a first side of the intermediate foil and the fastening device adjoins on a second side of the intermediate foil different from the first side, in particular opposing the first side. In particular, the fastening device is, for example directly, supported on the bearing device via the foil. By the intermediate foil provided with the particles, a friction coefficient between the bearing device and the fastening device can be particularly increased, whereby a friction fit between the bearing device and the fastening device can be particularly improved. Thereby, the mechanical load capacity of the wheel suspension can be particularly improved.

Alternatively or additionally, it is for example provided that a bearing part of the bearing device, in particular different from a screw element, in particular directly, arranged at the fastening device, is connected to the fastening device, in particular to the first and/or the second fastening element, at least in form-fitting manner. In other words, for fastening the bearing device, in particular the bearing part, to the fastening device, at least a form fit is provided between the bearing part and the fastening device, which can for example be designed as a cylindrical sleeve, as a conical seat or as a spherical seat. Thereby, it can be avoided that an available friction force between both friction partners is no longer sufficient in case of overload and slipping of the connection occurs. Thereby, the mechanical load capacity of the wheel suspension can be particularly improved.

A further aspect relates to a motor vehicle, which comprises at least one wheel suspension according to the invention. Advantages and advantageous configurations of the invention are to be regarded as advantages and advantageous configurations of the further aspect and vice versa. A method for producing the wheel suspension according to the invention, in particular of the motor vehicle, is also disclosed.

Numerals such as for example “first”, “second”, “third” etc. are in particular only provided for differentiating and in particular do not designate an order. That is, the corresponding numerals can in particular be arbitrarily exchanged with each other.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone.

Now, the invention is explained in more detail based on a preferred embodiment as well as with reference to the drawings. There show:

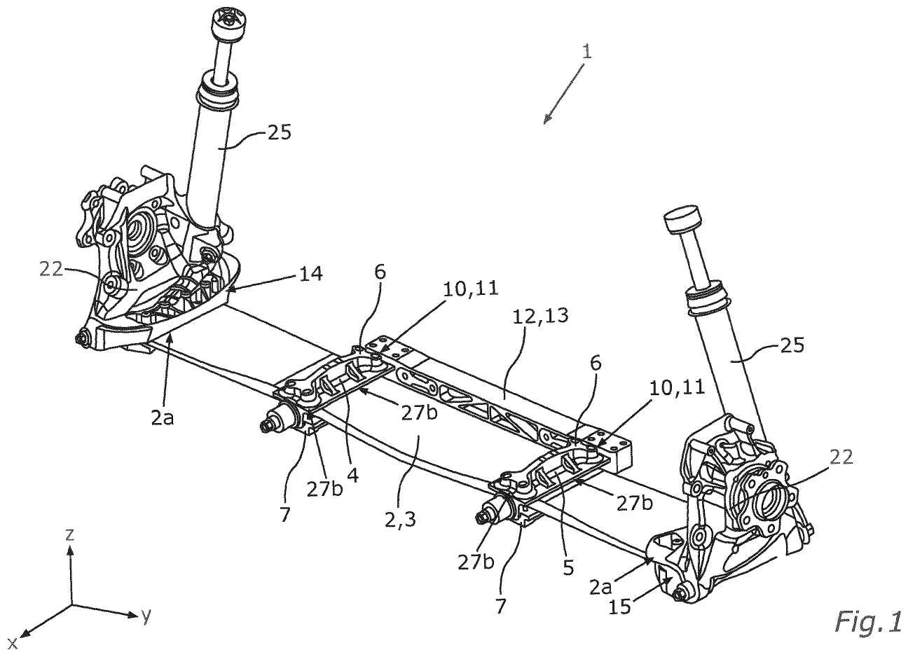

FIG. 1 a schematic perspective view of a wheel suspension according to the invention; and

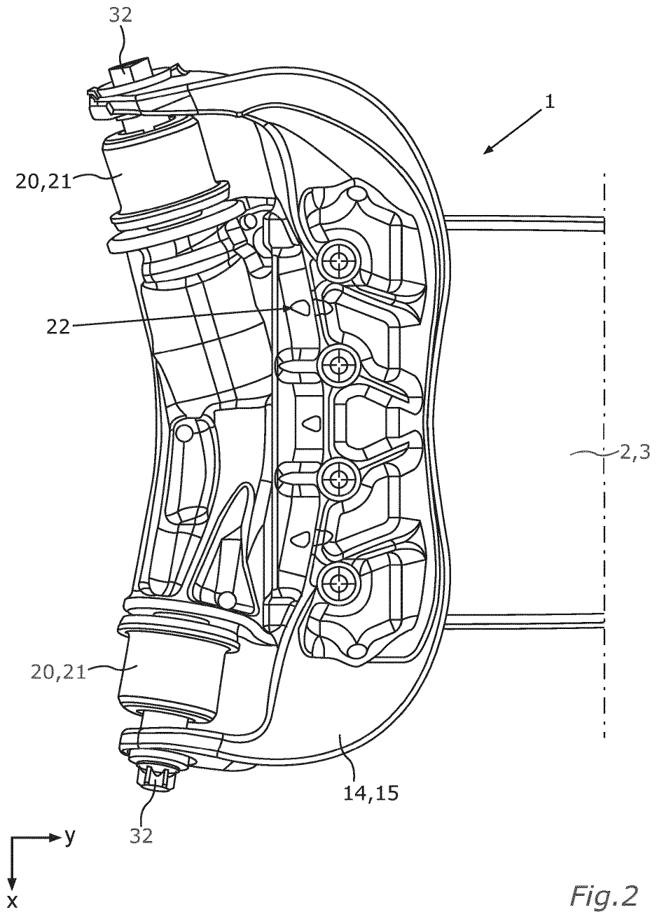

FIG. 2 a schematic partial view of a wheel suspension according to the invention from below; and

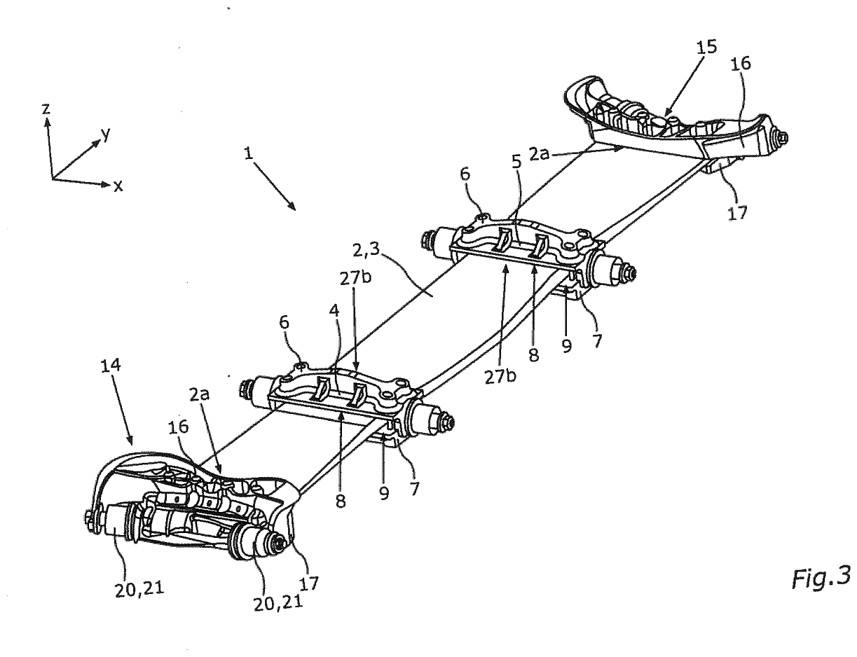

FIG. 3 a schematic and perspective partial view of a wheel suspension according to the invention; and

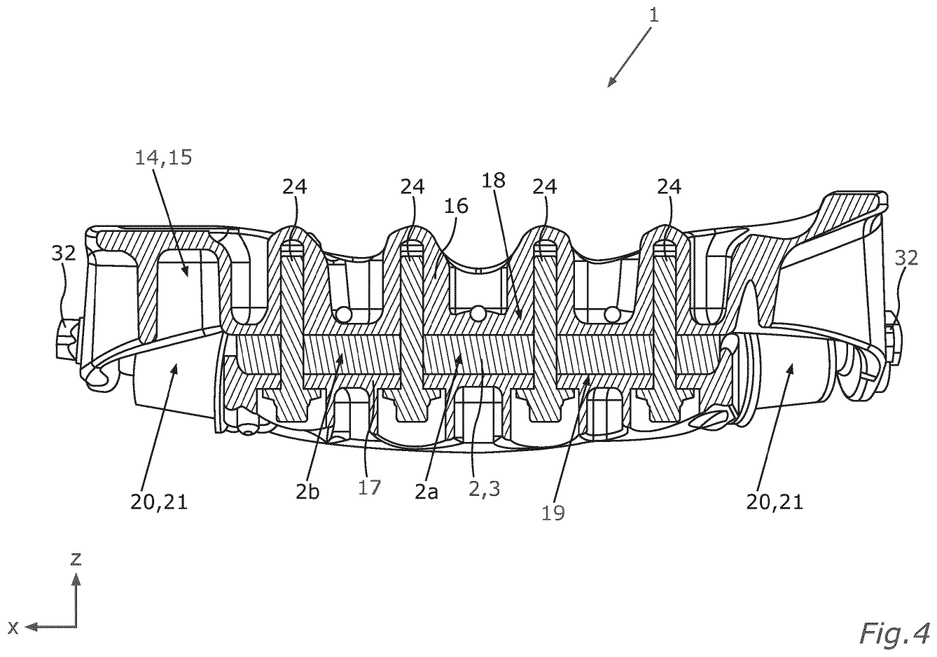

FIG. 4 a schematic partial sectional view of a wheel suspension according to the invention; and

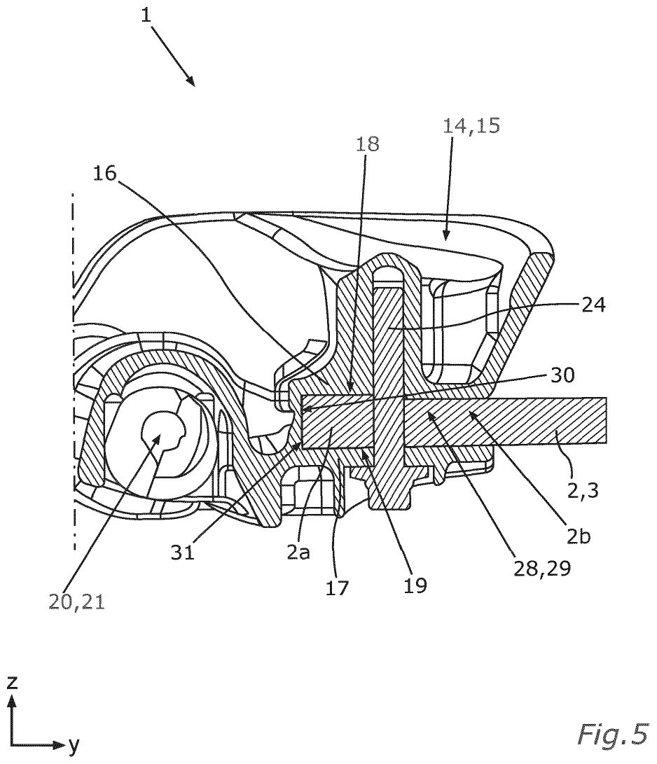

FIG. 5 a further schematic partial sectional view of a wheel suspension according to the invention; and

FIG. 6 a further schematic partial sectional view of a wheel suspension according to the invention; and

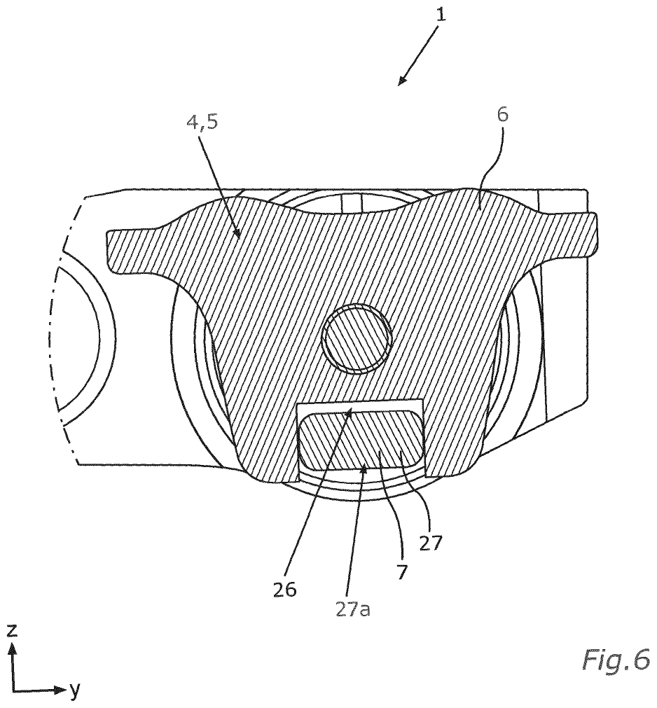

FIG. 7 a further schematic partial sectional view of a wheel suspension according to the invention; and

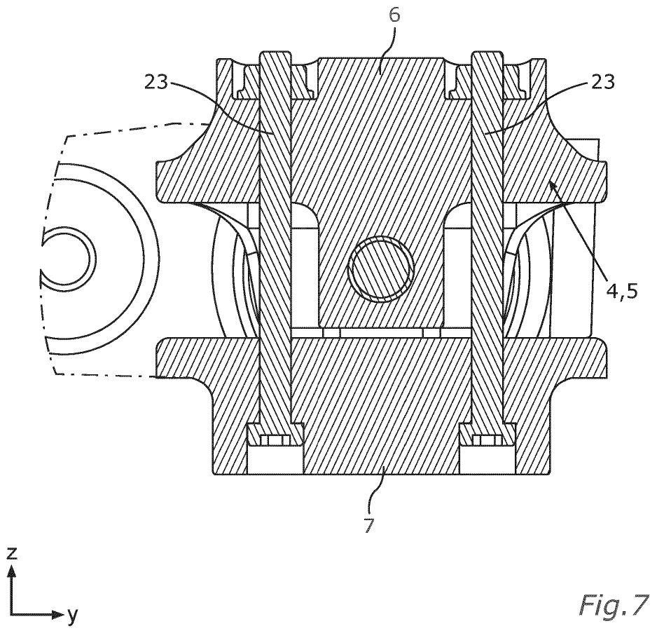

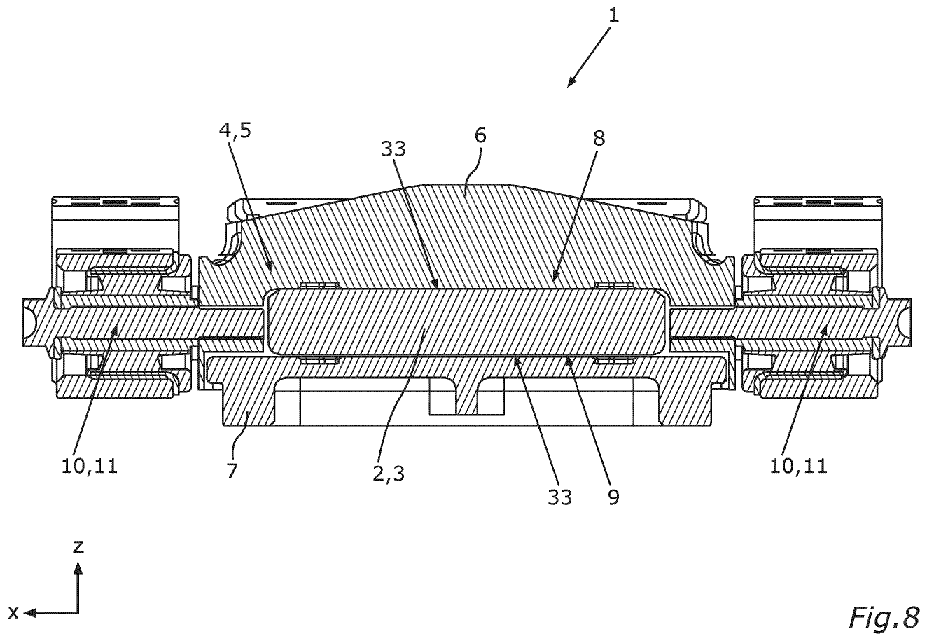

FIG. 8 a further schematic partial sectional view of a wheel suspension according to the invention; and

FIG. 9 a further schematic partial sectional view of a wheel suspension according to the invention; and

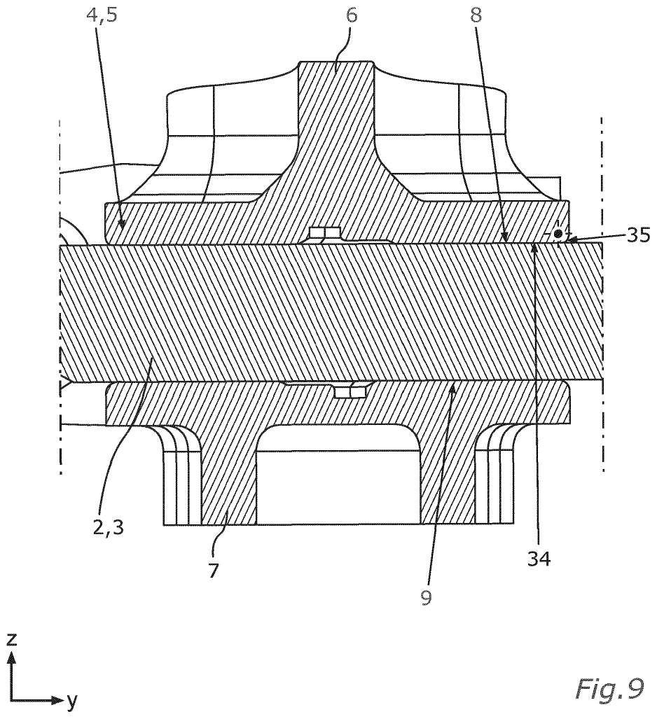

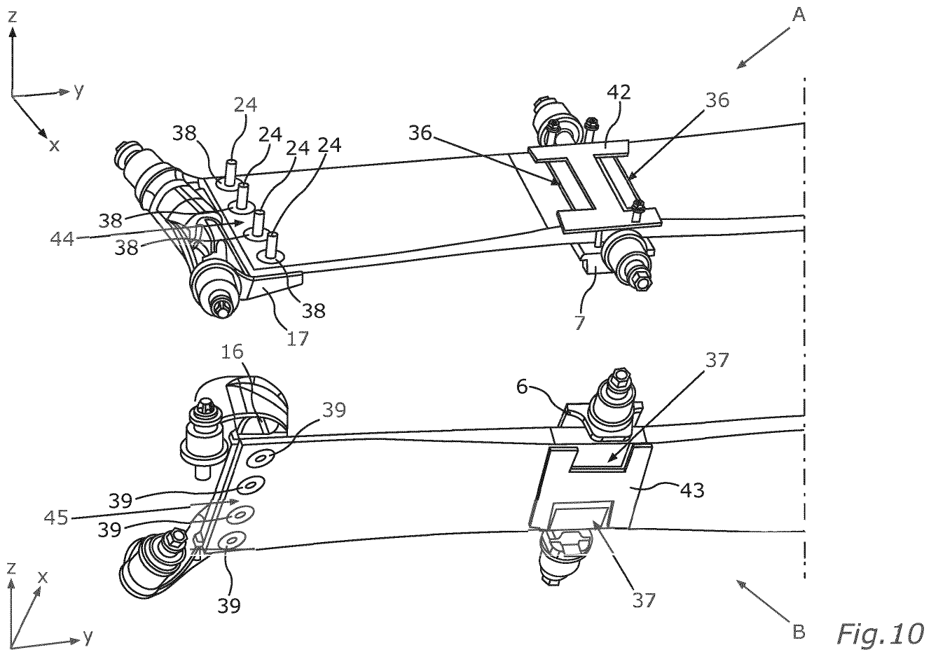

FIG. 10 schematic and perspective partial views of a wheel suspension according to the invention; and

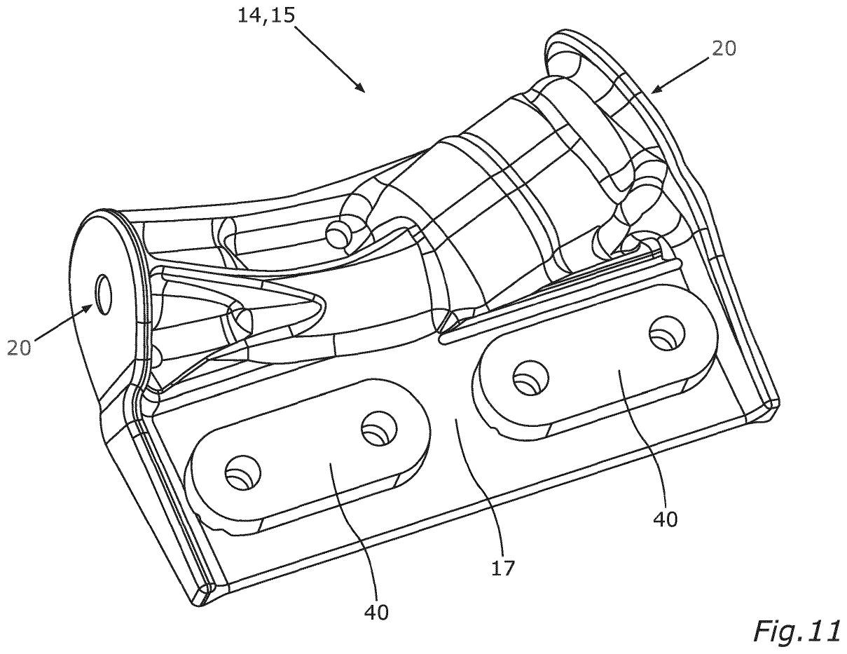

FIG. 11 a schematic and perspective partial view of an arrangement of at least one manufacturing auxiliary means at a wheel suspension according to the invention; and

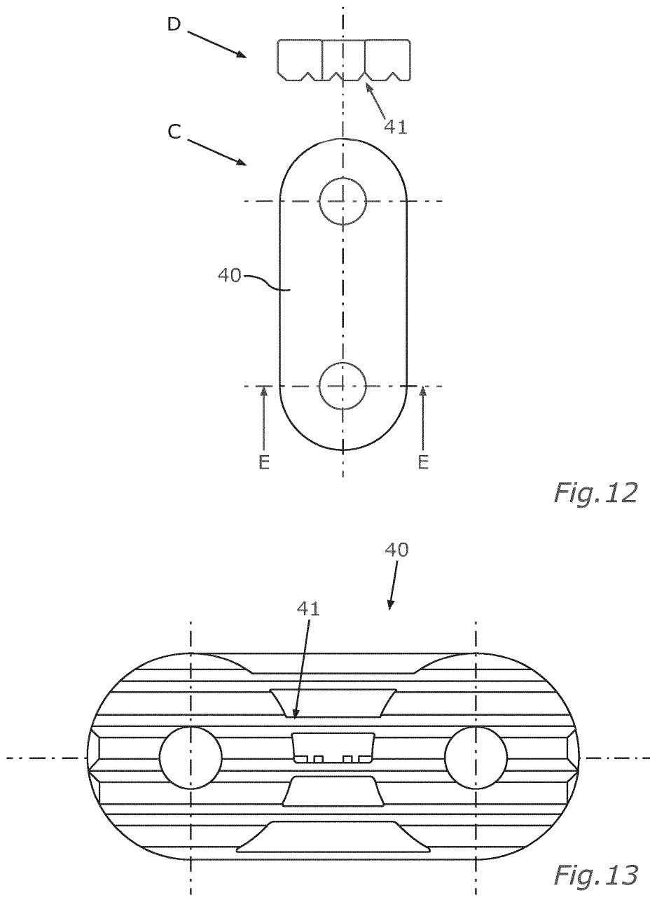

FIG. 12 a schematic top view and a schematic partial sectional view of a manufacturing auxiliary means; and

FIG. 13 a further schematic partial sectional view of the manufacturing auxiliary means from FIG. 13; and

FIG. 14 a schematic top view of a foil and a plastic foil of a wheel suspension according to the invention; and

FIG. 15 a schematic top view of a foil and a plastic foil of a wheel suspension according to the invention according to a further embodiment; and

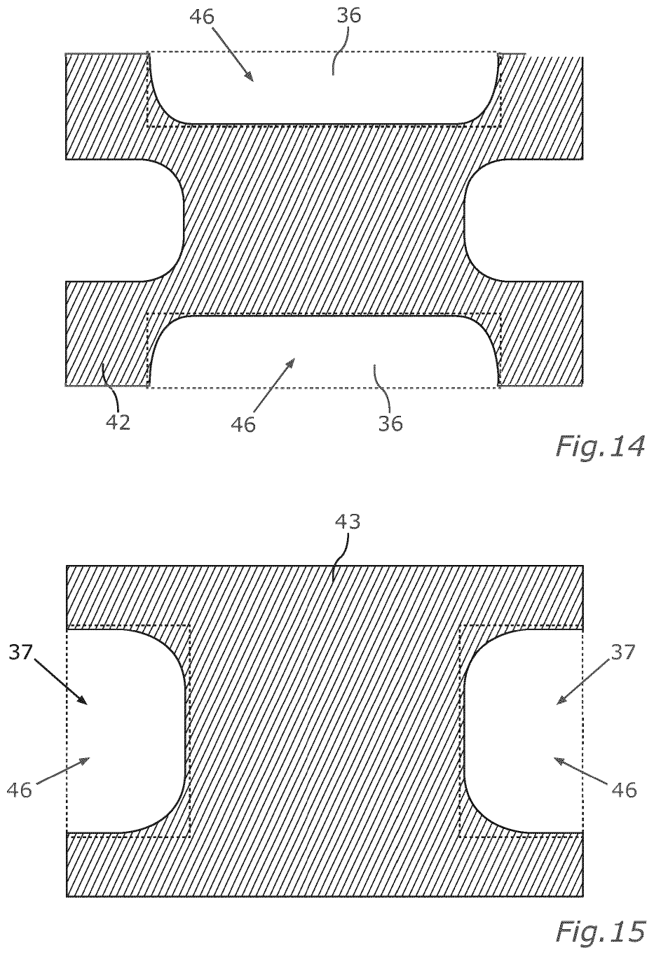

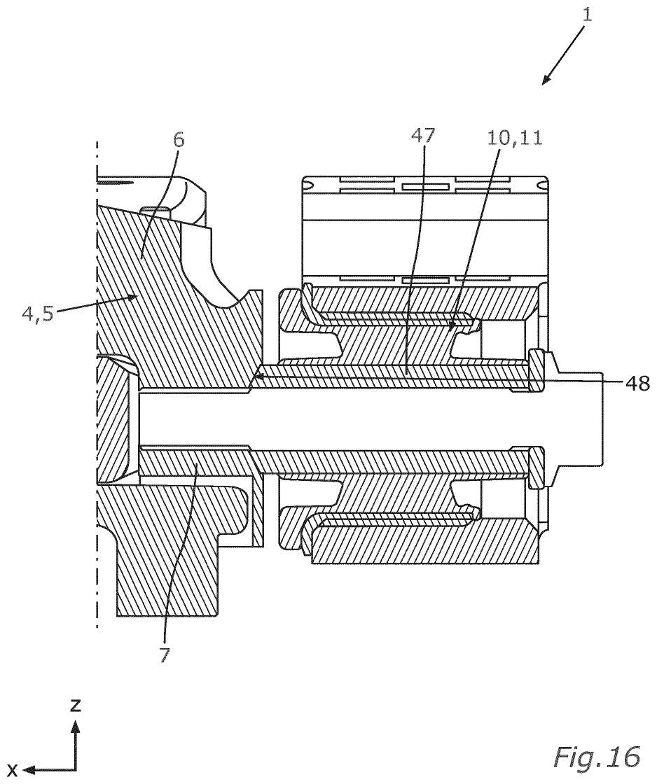

FIG. 16 a schematic partial sectional view of a wheel suspension according to the invention according to a further embodiment; and

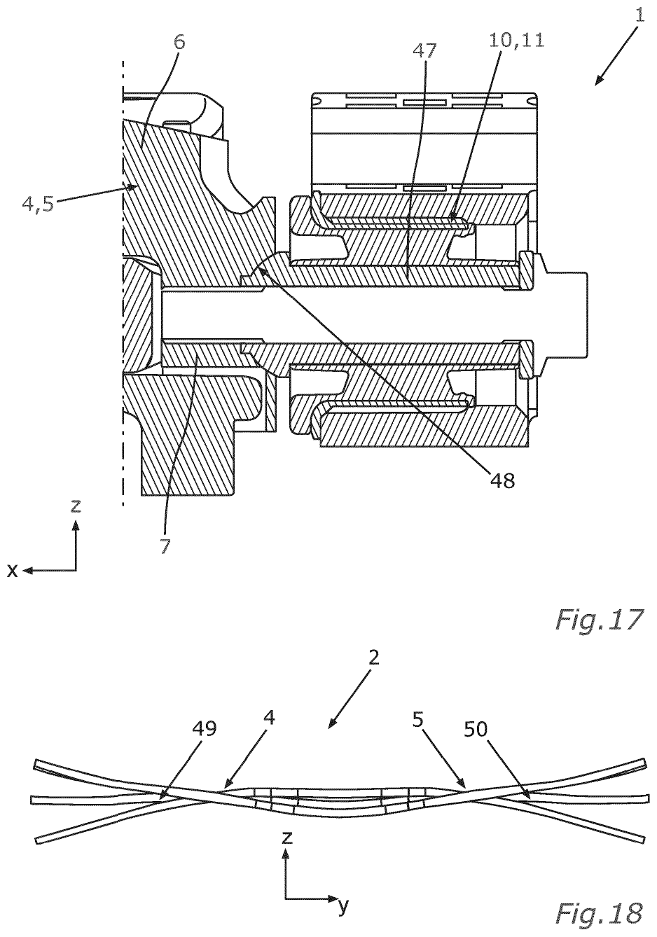

FIG. 17 a schematic partial sectional view of a wheel suspension according to the invention according to a further embodiment; and

FIG. 18 a schematic front view of a spring link of a wheel suspension according to the invention for illustrating a bending of the spring link; and

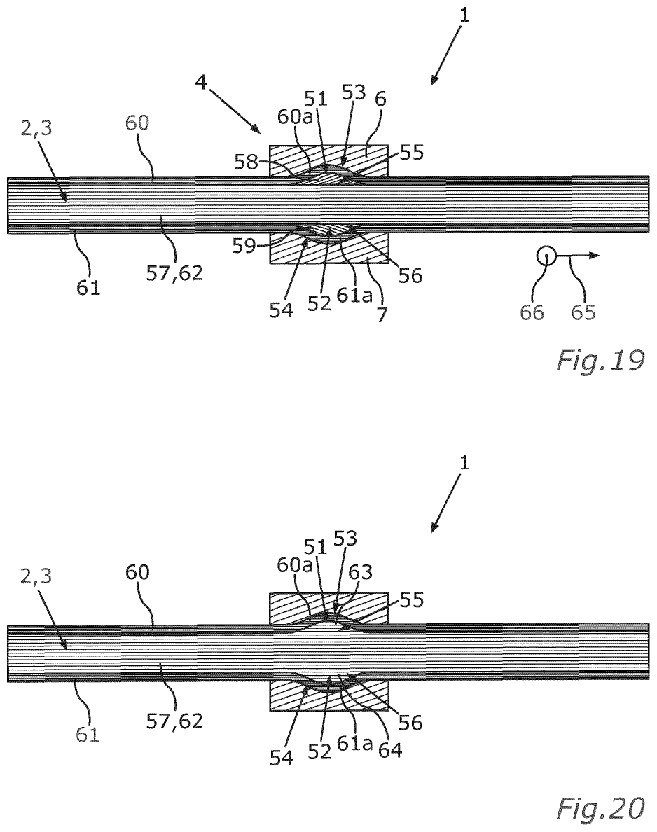

FIG. 19 a schematic partial sectional view of a wheel suspension according to the invention according to a further embodiment; and

FIG. 20 a schematic partial sectional view of a wheel suspension according to the invention according to a further embodiment.

In the figures, identical or functionally identical elements are provided with identical reference characters.

FIG. 1 shows a wheel suspension 1 for a motor vehicle in a schematic perspective view. FIG. 2 shows the wheel suspension 1 in a schematic partial view from below. FIG. 3 shows the wheel suspension 1 in a schematic and perspective partial view.

In the embodiment, the wheel suspension 1 is formed as a wheel suspension for a rear axle of the motor vehicle. Thus, the wheel suspension 1 is for example arranged in a rear area of the motor vehicle. Alternatively, the wheel suspension 1 is for example formed as a wheel suspension for a front axle of the motor vehicle. In particular, the wheel suspension 1 is formed for a driven axle, in particular driven rear axle, of the motor vehicle.

The wheel suspension 1 comprises at least one spring link 2 provided or formed for guiding at least one vehicle wheel, which is formed as a leaf spring element 3. A main extension direction of the spring link 2 or of the leaf spring element 3 preferably extends in vehicle transverse direction y of the motor vehicle. Therefore, the spring link 2 or the leaf spring element 3 can for example be referred to as transverse leaf spring.

The wheel suspension 1 comprises at least one fastening device 4 formed separately from the spring link 2. In the embodiment shown in FIG. 1 and FIG. 3, two fastening devices 4, 5 are provided. Thus, the wheel suspension 1 for example comprises a first fastening device 4 and a second fastening device 5 formed separately from the fist fastening device 4 and in particular spaced from the first fastening device 4 in vehicle transverse direction y. Preferably, the fastening devices 4, 5 are formed separately from the spring link 2. The respective fastening device 4, 5 respectively comprises at least two respective fastening elements 6, 7 formed separately from each other. The respective fastening element 6, 7 respectively comprises a respective abutment surface 8, 9, between which the spring link 2 is arranged. Thus, the respective first fastening element 6 for example comprises a respective first abutment surface 8 and the respective second fastening element 7 for example respectively comprises a respective second abutment surface 9. In the embodiment, the spring link 2 is supported on the respective first fastening element 6 upwards in vehicle vertical direction z of the motor vehicle, in particular via the respective first abutment surface 8. The spring link 2 is supported on the respective second fastening element 6 downwards in vehicle vertical direction z via the respective second abutment surface 9. The spring link 2 is connected to the respective fastening device 4, 5, in particular to the respective fastening elements 6, 7, via the abutment surfaces 8, 9 at least in force-fitting manner, in particular direct manner.

The respective fastening device 4, 5 respectively comprises a respective first bearing location 10. A respective first bearing device 11 is preferably arranged at the respective first bearing location 10, which is for example formed as a rubber bearing. Via the respective first bearing location 10, in particular via the respective first bearing device 11, the spring link 2 can be coupled or is coupled to at least one component 12 of a structure, in particular a body and/or a chassis, of the motor vehicle in articulated manner, in particular via the respective fastening device 4, 5. For example, the component 12 is formed as a cross member of a rear axle carrier of the motor vehicle.

The wheel suspension 1 comprises at least one holding device 14 formed separately from the spring link 2 and the respective fastening device 4, 5. In the embodiment, the wheel suspension comprises two holding devices 14, 15, which are formed separately from each other, and in particular are spaced from each other in vehicle transverse direction y. The holding devices 14, 15 are formed separately from the spring link 2 and the fastening devices 4, 5. The respective holding device 14, 15 respectively comprises two respective holding parts 16, 17. The respective holding device 14, 15 is for example illustrated in FIG. 2. FIG. 4 and FIG. 5 each show a respective schematic partial sectional view of the wheel suspension 1, wherein the respective holding device 14, 15 is illustrated in FIG. 4 and FIG. 5.

The respective holding part 16, 17 respectively comprises a respective support surface 18, 19, between which the spring link 2 is arranged. Thus, the respective first holding part 16 for example comprises a respective first support surface 18 and the respective second holding part 17 for example respectively comprises a respective second support surface 19. In the embodiment, the spring link 2 is for example supported on the respective first holding part 16 upwards in vehicle vertical direction z, in particular via the respective support surface 18. For example, the spring link 2 is supported on the respective second holding part 17 downwards in vehicle vertical direction z, in particular via the respective second support surface 19. Via the support surfaces 18, 19, the spring link 2 is, in particular directly, connected to the respective holding device 14, 15 at least in force-fitting manner.

The respective holding device 14, 15 respectively comprises a respective second bearing location 20, at which a respective second bearing device 21 is preferably arranged, which is for example formed as a respective rubber bearing. Via the respective second bearing location 20, in particular via the respective second bearing device 21, the spring link 2 is, in particular directly, connected or connectable to a respective wheel carrier 22, in particular via the respective holding device 14, 15. The respective wheel carrier 22 is for example illustrated in FIG. 1 and FIG. 2. At least one respective vehicle wheel of the motor vehicle is respectively held or to be held at the respective wheel carrier 22. Thus, the spring link 2 can be or is coupled to the respective vehicle wheel in articulated manner via the respective second bearing location 20, in particular via the respective second bearing device 21. Thus, the spring link 2 is for example connected to the wheel carriers 22 on the one hand and to the body on the other hand for example via rubber bearings.

The respective fastening element 6, 7 is preferably formed as a respective clamping element. This means that the force-fitting connection between the spring link 2 and the fastening elements 6, 7 is a respective clamping connection. Preferably, the fastening elements 6, 7 of the respective fastening device 4, 5 are screwed to each other, in particular for effecting the clamping connection, that is connected to each other by means of at least one screw element 23. The at least one screw element 23 is preferably arranged outside of the spring link 2. This means that the at least one screw element 23 does not extend through the spring link 2 such that the screw connection between the respective fastening elements 6, 7 is for example formed while bypassing the spring link 2.

Preferably, the respective holding part 16, 17 is formed as a respective clamping part. This means that the force-fitting connection of the holding parts 16, 17 of the respective holding device 14, 15 is a respective clamping connection. Preferably, the holding parts 16, 17 of the respective holding device 14, 15 are screwed to each other, in particular for effecting or forming the clamping connection, that is connected to each other by means of at least one screw element 24. For example, the screw connection extends through the spring link 2. Thus, the spring link 2 is in particular screwed to the respective holding parts 16, 17 by means of the at least one screw element 24.

In the embodiment, the respective holding device 14, 15 is arranged further to the outside in vehicle transverse direction y than the respective fastening device 4, 5. Thereby, an inner mounting of the spring link 2 can in particular be understood by the fastening devices 4, 5 and inner clamping elements can in particular be understood by the fastening elements 6, 7. In particular, a respective outer mounting of the spring link 2 can be understood by the respective holding device 14, 15 and outer clamping parts can in particular be understood by the holding parts 16, 17.

In the embodiment shown in FIG. 2, the wheel suspension 1 comprises two spring and/or damper devices 25 formed separately from the spring link 2. The respective spring and/or damper device 25 is, in particular directly, arranged at the respective wheel carrier 22. Via the respective spring and/or damper device 25, the respective vehicle wheel can be or is supported on the structure 13 in spring-mounted and/or damped manner. Thus, a driven or drivable damper strut rear axle with wheel guiding transverse leaf spring is in particular shown in the embodiment shown in FIG. 1.

In order to be able to particularly increase a mechanical load capacity of the wheel suspension 1, it is provided that the respective first fastening element 6 comprises at least one respective receiving opening 26 and the respective second fastening element 7 respectively comprises a respective connection part 27. The respective connection part 27 and in particular the respective receiving opening 26 is not formed as a respective screw element, and in particular not formed as the respective first screw element 23 or the respective second screw element 24. The respective connection part 27 is arranged in the respective receiving opening 26 for forming a respective form-fitting connection, which can in particular be referred to as first form fit 27a, between the fastening elements 6, 7 of the respective fastening device 4, 5. This is illustrated in FIG. 6, in which a schematic partial sectional view of the wheel suspension 1 is shown. Thus, in order that the second fastening element 7 formed as a respective lower clamping part can contribute to a support of lateral forces, a respective form fit is for example respectively provided between the fastening elements 6, 7 of the respective fastening device 4, 5. Therein, a projection in the lower clamping element can for example engage with an accurately fitting recess in the upper clamping element for example similar to a tongue-and-groove joint connection, whereby the two clamping elements can thereby be fixed to each other, optionally nearly without clearance to each other, for example in vehicle transverse direction y. Thus, the connection part 27 is preferably the projection and the receiving opening 26 is preferably the accurately fitting recess. For a particularly secure transfer of transverse forces, the friction force established by the respective friction-fitting connection is provided, which can be supported from the respective second abutment surface for example formed as a respective lower clamping surface by its preload force in connection with a friction coefficient.

In order to be able to particularly increase the mechanical load capacity of the wheel suspension, it is alternatively or additionally provided that the respective holding parts 16, 17 are respectively formed separately from each other and at least the respective support surface 18, 19 of one of the respective holding parts 16, 17 is, in particular directly, connected to the spring link 2 in form-fitting manner. In the embodiment shown in FIG. 4 and FIG. 5, the respective first support surface 18 and the respective second support surface 19 of the respective holding part 16, 17 of the respective holding device 14, 15 are respectively, in particular directly, connected to the spring link 2 in form-fitting manner. This means that the respective support surfaces 18, 19 are connected to the spring link 2 by means of a second form fit 2b. This second form fit 2b can act as an overload protection for outward forces, which attempt to extract the spring link 2 out of the respective holding device 14, 15. Overall, it is recognizable that a particularly advantageous force introduction for a spring link axle can be effected by means of the wheel suspension 1.

In the embodiment shown in FIG. 5, it is provided that the support surfaces 18, 19 of the respective holding device 14, 15 at least partially delimit a receiving space 29 formed as a respective undercut 28, in which a respective fastening area 2a of the spring link 2 is arranged for form-fitting connection of the spring link 2 to at least one of the holding parts 16, 17 of the respective holding device 14, 15, in particular to both respective holding parts 16, 17 of the respective holding device 14, 15. Preferably, the respective fastening area 2a is formed wedge-shaped. This means that the spring link has a wedge-shaped contour in the area of the respective fastening area 2a.

In further configuration, it is provided that at least one of the respective holding parts 16, 17, in particular the respective first and/or the respective second holding part 16, 17, of the respective holding device 14, 15 respectively comprises a respective stop area 30, 31 extending obliquely or perpendicularly to the respective support surface 18, 19 of the respective holding part 16, 17, on which the spring link 2, in particular directly, abuts. In the embodiment, the respective first holding part 16 therein comprises a respective first stop area 30 and the respective second holding part 17 comprises a respective second stop area 31. The spring link 2 can be or is supported outwards in vehicle transverse direction y on the respective stop area 30, 31.

In order to be able to effect a uniform distribution of a, in particular required, screw preload force, at least two, in particular three or four, of the screw elements 24 are for example provided, which each are or will be screwed into threaded blind holes in the respective first holding part 16. Such a solution can do without separate nuts. Further, the respective screwing or a respective screwing area can be particularly securely protected from corrosive attack, that is with respect to corrosion. Preferably, a respective toe adjustment is provided, which is for example arranged or formed at the connection of the second bearing device 21 or at the second bearing location 20. The toe adjustment for example is or will be realized via a respective eccentric screw 32. For example, the respective eccentric screw 32, in particular together with an associated eccentric disc, is, in particular directly, supported in at least one respective groove in the respective first holding part 16 and/or in the respective second holding part 17. In order to provide sufficient installation space to a torque wrench in tightening the respective eccentric screw 32 or the respective eccentric screwing, the respective second holding part 16 can comprise a large, for example barrel-shaped, recess, which can ensure a sufficient stiffness for the loads occurring there. For an adjustment range, elongated holes are for example provided, which for example extend substantially in vehicle transverse direction y. In order to be able to compensate for thickness tolerances in the spring link 2, the respective elongated hole can be designed larger, in particular additionally, in vehicle vertical direction z, in particular slightly, for example by several tenths of a millimeter, than a respective screw diameter of the respective eccentric screw 32. Otherwise, thickness tolerances for example cannot, in particular negatively, affect a stress of the respective holding parts 16, 17 in contrast to a holding device formed integrally or in one piece.

As is for example particularly well apparent in FIG. 2, it is for example provided that the respective wheel carrier 22 is connected to the respective holding device 14, 15 in articulated manner for example respectively via respectively two of the second bearing devices 21 in particular formed as a rubber bearing. Therein, the second bearing devices 21 are preferably respectively arranged inclined to each other, in particular in V-shaped manner. Thereby, a desired behavior for toe changes and/or camber changes in compression and rebound can be achieved. Preferably, the respective second bearing device 21 is pressed in the respective wheel carrier 22.

Preferably, the spring link 2 is formed of a fiber composite material, for example a carbon fiber composite material or a glass fiber composite material. Preferably, the respective fastening element 6, 7 is not designed in shell construction, but for example respectively solidly formed. For example, the respective first fastening element 6 respectively has a U-shaped profile, that means that the respective first fastening element 6 is at least partially shaped U-shaped. For example, the respective fastening element 6, 7 is at least partially, in particular completely, formed of a metallic material, in particular of steel or of aluminum. In particular, the respective fastening element 6, 7 is designed as a cast part or as a forged part. Thereby, a sufficiently high surface pressure between the respective fastening element 6, 7 and the spring link 2 can be achieved, such that the surface pressure is particularly well suitable for the transfer of particularly high forces occurring in particularly heavy vehicles. Therein, a target conflict between a surface pressure as high as possible in terms of operating safety on the one hand and occurring stresses in the matrix material of the fiber composite material of the spring link 2 on the other hand can arise. In particular, transverse tensile stresses and/or compressive stresses and/or shear stresses are not allowed to exceed limits preset on the side of material. Conventional screw joints can have large fluctuations in an achieved or achievable screw preload force at the same tightening torque depending on the currently present friction coefficient. In order to still be able to particularly securely transfer the occurring forces and/or not to exceed limits on the side of material, the respective screw joint, in particular the screw joint effected by means of the at least one first screw element 23 and/or by means of the at least one second screw element 24, is for example designed such that a relatively small screw dimension is for example first selected, but which is then plastically tightened. Put in other words, the at least one respective first screw element 23 and/or the at least one respective second screw element 24 is plastically tightened. Therein, a combination of snug torque and subsequent rotational angle can be set such that it can be ensured that an elastic limit of a respective screw material is exceeded. By the subsequent rotational angle, a deformation can be applied, at which a stress in the screw shaft is between an elastic limit and a yield strength. A screw preload force effective therein can thereby be approximately constant independently of the friction coefficient. Thereby, operating loads can be transferred and an overload of the matrix material can be particularly securely avoided. For example, this is illustrated in FIG. 7, in which a respective schematic partial sectional view of the wheel suspension 1 is shown.

Preferably, it is provided that at least one of the respective abutment surfaces 8, 9, in particular the respective first abutment surface 8 and/or the respective second abutment surface 9, respectively comprises a respective bulge 33. In other words, contact surfaces of the holding parts 16, 17 are formed spherical to the spring link 2 for achieving a uniform surface pressure. This is illustrated in FIG. 8, in which a schematic partial sectional view of the wheel suspension 1 is shown.

FIG. 9 shows the wheel suspension 1 in a schematic partial sectional view. For example, the respective abutment surface 8, 9 comprises a respective radius 34 in particular different from the bulge 33, which is for example 100 millimeters. Therein, the radius 34 can help to reduce edge loading in compression and rebound movement of the spring link. Stress peaks are meant thereby, which can occur in particularly large wheel travels of the vehicle wheel between edges of the respective fastening element 6, 7 and the spring link 2. Therein, a particularly large radius at the edge of the respective support surface 8, 9 of the respective fastening element 6, 7 on the spring link 2 in the order of 100 millimeters, in particular with a second radius 35 different from the radius 34, of several millimeters at a respective outer edge of the respective fastening element 6, 7 has proved itself. Thus, the second radius 35 is for example respectively arranged at the respective outer edge of the respective fastening element 6, 7, in particular at the respective abutment surface 8, 9.

A dimensioning of the fastening elements 6, 7 can be significantly dependent on which operating loads are to be transferred and which friction coefficients are present in the respective abutment surface 8, 9 in particular referred to as contact surface. In particular in terms of small, light components with little effects on package and weight, it can therefore be reasonable to provide friction coefficient increasing measures. These friction coefficient increasing measures can be, in particular particularly thin, foils 36, 37, 38, 39 with particles, which can be inserted between clamping partners to be screwed. Thus, the wheel suspension 1 for example comprises at least one foil 36, 37, 38, 39 provided with particles, in particular with diamond particles, silicon carbide particles and/or corundum particles, which is arranged between the spring link 2 and the respective fastening device 4, 5 and/or the respective holding device 14, 15.

In the embodiment shown in FIG. 10, in which two schematic and perspective partial views A, B of the wheel suspension 1 are shown, multiple foils 36, 37, 38, 39 provided with particles, in particular with diamond particles, silicon carbide particles and/or corundum particles, in particular different from each other, are provided. A respective first one of the foils 36 is respectively arranged between the spring link 2 and the respective first fastening element 6. Preferably, the first foil 36 directly contacts the spring link 2 and/or the fastening element 6. A respective second one of the foils 37 is respectively arranged between the spring link 2 and the respective second fastening element 7. Preferably, the respective second foil 37 directly contacts the spring link 2 and/or the respective second fastening element 7. The respective foil 36, 37 is for example rectangularly formed or formed as a respective rectangular section. Preferably, the respective foil 36, 37 is arranged in the area of the highest surface pressure. A respective third one of the foils 38 is respectively arranged between the spring link 2 and the respective first holding part 16. For example, the respective third foil 38 directly contacts the spring link 2 and/or the respective holding part 16. A respective fourth one of the foils 39 is respectively arranged between the spring link 2 and the respective second holding part 17. For example, the respective fourth foil 39 directly contacts the spring link 2 and/or the respective second holding part 17. For example, the respective foil 38, 39 is formed disc-shaped and in particular arranged around the respective screw element 24.

In particular in material pairing between aluminum or steel to the fiber composite material, however, the problem can occur that the hardnesses of the two friction partners can be very different. Without further measures, the particles therefore could nearly exclusively press into the soft material, in this case into the matrix of the fiber composite material, and thereby not establish a sufficient connection to the harder material of the fastening device 4, 5 and/or the holding device 14, 15. In order to avoid this, a preconditioning of the respective foils 36, 37, 38 and/or 39 can be performed, in particular on the respectively harder friction partner. Therein, the respective foil 36, 37, 38 and/or 39 can be placed on the respective fastening element 6, 7 or on the respective holding part 16, 17 and be pressed with a surface pressure of for example at least 60 Megapascal to ensure a sufficient form fit. This surface pressure can for example be generated either via a hydraulic press or else by screwing with the respective screw element 23, 24, which is provided for the connection of the two friction partners. In this case, it is in particular to be noted that the screwing is to be designed for the maximally allowable surface pressure of the matrix material, wherein this surface pressure is for example considerably below the required value for preconditioning of the friction coefficient increasing respective foil 36 to 39. In other words, at least one of the foils 36 to 39 is pressed with the fastening device 4, 5 or the holding device 14, 15, in particular for preconditioning the respective foil 36 to 39. For example, the respective first foil 36 is pressed with the respective first fastening element 6. For example, the second foil 37 is pressed with the respective second fastening element 7. For example, the respective third foil 38 is pressed with the respective first holding part 16. For example, the respective fourth foil 39 is pressed with the respective second holding part 17.

Preconditioning or pressing is for example performed by means of a manufacturing auxiliary means 40, which is for example formed as a pressure piece. In particular, a tool can be understood by the manufacturing auxiliary means. FIG. 11 exemplarily shows an arrangement of two such pressure pieces at the respective holding device 14, 15, in particular at the respective second holding part 17. FIG. 12 shows the manufacturing auxiliary means 40 in a top view C and in a schematic partial sectional view D, which extends between section reference points E. The manufacturing auxiliary means 40 for example comprises a groove structure 41, that is multiple grooves, in particular on a surface. FIG. 13 shows the manufacturing auxiliary means 40 in a schematic partial sectional view, in which the groove structure 41 is particularly well apparent. This partial sectional view is a section, which extends between section reference points E, which are illustrated in FIG. 12. By the groove structure 41, a respective support surface can be reduced to about half, whereby the required surface pressure for the preconditioning can be particularly securely achieved. If one uses two pressure pieces with offset grooves, the support surfaces of which overlap with each other, the entire surface of the respective friction coefficient increasing foil 36 to 39 can be preconditioned with sufficient surface pressure with the present component screwing in two setups. In particular, the preconditioning can be performed by means of screwing by means of the respective pressure piece.

In further configuration, at least one plastic foil 42, 43, 44, 45 different from the respective foil 36 to 39 is provided, which is arranged between the spring link 2 and the fastening device 4, 5 or the holding device 14, 15 at least partially without overlap with the respective foil 36 to 39. In the embodiment, a respective first plastic foil 42 is respectively arranged between the spring link 2 and the respective first fastening element 6. The first plastic foil 42 is arranged at least partially, in particular completely, without overlap with the first foil 36. A respective second plastic foil 42 is respectively arranged between the spring link 2 and the respective second fastening element 7, which is at least partially without overlap with the second foil 37. At least one respective third plastic foil 44 is respectively arranged between the spring link 2 and the respective first holding part 16, which is at least partially without overlap with the third foil 38. At least one fourth plastic foil 45 is respectively arranged between the spring link 2 and the respective second holding part 17, which is at least partially without overlap with the fourth foil 39. Preferably, the plastic foils 42 to 45 are different from each other and in particular spaced from each other. The respective plastic foil 42 to 45 is for example formed of ABS. A wear protection of the spring link 2, in particular of the matrix material, can be effected by means of the respective plastic foil 42 to 45.

It can be reasonable to arrange the friction coefficient increasing measures, in particular in the form of the respective foil 36 to 39, in the area of the highest surface pressures, to be able to transfer forces as high as possible. On the other hand, the wear protection of the spring link 2, in particular of the matrix material, by the plastic foils 42 to 45 can also be particularly important in the same area. In that the respective plastic foil 42 to 45 is arranged at least partially without overlap with the respective foil 36 to 39, the foils 36 to 39 and the plastic foils 42 to 45 are for example not, in particular directly, arranged above each other. Thereby, it can be avoided that a particularly low hardness of the respective plastic foil 42 to 45 impairs an effect of the friction coefficient increasing measures. This means that it can for example be avoided that the particles especially penetrate into the plastic foil 42 to 45, whereby a sufficient form fit with the, in particular metallic, clamping parts or clamping elements cannot arise. Preferably, the respective foil 36 to 39 at least partially extends in a respective recess 46 of the respective plastic foil 42 to 45. This means that the first foil 36 for example extends into at least one recess 46 of the first plastic foil 42. For example, the second foil 37 at least partially extends into at least one recess of the second plastic foil 43. For example, the third foil 38 at least partially extends into at least one recess of the third plastic foil 44. For example, the fourth foil 39 at least partially extends into a recess of the fourth plastic foil 45. Thereby, a compromise can be found, which gives priority to the protection or wear protection of the spring link 2, such that the respective plastic foil 42 to 45 is for example arranged in the area of the highest stress peaks and the respective friction coefficient increasing foil 36 to 39 for example immediately besides.

FIG. 14 shows the first foil 36 and the first plastic foil 42 in a schematic top view. FIG. 15 shows the second foil 37 and the second plastic foil 43 in a schematic top view. In particular, the first foil 36 and the first plastic foil 42 are, in particular directly, arranged on a top side of the spring link 2 related to the vehicle vertical direction z. For example, the second foil 37 and the second plastic foil 43 are, in particular directly, arranged on a bottom side of the spring link 2 related to the vehicle vertical direction z. As apparent in synopsis of FIG. 14 and FIG. 15, as a result of different stresses for the top side and the bottom side of the spring link 2, arrangements or shapes of the foils 36, 37 and the plastic foils 42, 43 different from each other can be provided. For example, the plastic foils 42, 43 differ with respect to their recess 46 or their respective recesses 46. This means that a respective shape and/or a respective position of the respective recess 46 is for example, in particular respectively, different in the plastic foils 42, 43. In particular, a respective shape of the foils 36, 37 is different.

For example, at least one friction coefficient increasing measure is also provided at the connection of the spring link 2 to the structure 13 or the component 12. For example, at least one foil provided with particles, in particular with diamond particles, silicon carbide particles and/or corundum particles, is arranged between the respective first bearing device 11 and the respective fastening device 4, 5, which can in particular be referred to as fifth foil. The fifth foil is for example annularly formed. Thus, the respective fifth foil can for example be inserted between a bearing part 47 of the respective first bearing device 11 in particular formed as an inner sleeve and the respective fastening device 4, 5, in particular similarly to the foils 36 to 39. The fifth foil can for example penetrate with its particles into both friction partners, for example under screw preload force, that is into the respective fastening device 4, 5, in particular into the respective first and/or second fastening element 6, 7, and into the respective first bearing device 11, in particular into the respective bearing part 47. Thereby a micro form fit can be effected. Here too, a preconditioning of the fifth foil with respect to the harder material, in this case the respective first bearing device 11, is for example provided, in particular in that an inner sleeve of the respective bearing device 11 for example formed as a rubber bearing can for example be formed of steel.

Alternatively or additionally, the bearing part 47 of the respective first bearing device 11, in particular directly, arranged at the respective fastening device 4, 5 can be or become connected to the respective fastening device 4, 5, in particular to the respective first and/or second fastening element 6, 7, at least in form-fitting manner, in particular in direct manner. This means that at least one third form fit 48 can for example be provided between the first bearing device 11 for example formed as a rubber bearing, in particular the inner sleeve, and an abutment surface on the respective fastening device 4, 5. For example, the third form fit 48 can be realized by means of conical seat, which is exemplarily illustrated in FIG. 16, which shows a schematic partial sectional view of the wheel suspension 1. Alternatively, the form fit 48 can for example be effected by means of a spherical seat, which is exemplarily shown in FIG. 17, which shows a schematic partial sectional view of the wheel suspension 1. Alternatively, the form fit 48 can for example be realized by means of a cylindrical sleeve.

FIG. 18 shows the spring link 2 in a schematic front view, in which a bending of the spring link 2 is illustrated. For package optimization, in particular for an area of the spring link 2 between the respective fastening device 4, 5 and the respective holding device 14, 15, it is preferably provided that a contour of the spring link 2 in this area is designed such that an approximately straight connection of both mountings, that is between the respective fastening device 4, 5 and the respective holding device 14, 15, is present in the state free of force. In other words, a respective first area 49, which extends between the first fastening device 4 and the first holding device 14, and/or a second area 50, in particular different from the first area 49, which extends between the second fastening device 5 and the second holding device 15, is on an, in particular respective, imagined straight line, in particular related to a vehicle longitudinal direction x of the motor vehicle viewed from the front and/or from the rear. In particular, a respective partial area of the spring link 2 can be understood by the respective area 49, 50. Preferably, a bending line of the spring link 2 deviates from the, in particular respective, straight line in compression downwards in vehicle vertical direction z and/or in rebound upwards in vehicle vertical direction z, and thereby avoids narrow sections to adjacent components. In other words, the spring link 2 has a shape different from the straight line in loaded state in the first and/or the second area 49, 50. In particular, a central area of the spring link 2 arranged between the areas 49, 50 in vehicle transverse direction y deviates from the straight line in normal position, in particular downwards in vehicle vertical direction z. For example, the normal position is not a load-free state since a static wheel load can act. Thereby, a height dimension chain particularly relevant to the rear axle can for example be particularly advantageously influenced. The height dimension chain for example includes a floor clearance line, a transverse leaf spring, in particular with force introductions, a rear axle gear or an electrical drive unit, a trunk well and/or a cargo floor or a cargo floor height.

FIG. 19 and FIG. 20 show the wheel suspension 1 according to a respective further embodiment in a respective schematic partial sectional view. Therein, at least one of the respective fastening elements 6, 7 comprises at least one respective receiving area 53, 54, in which a respective receiving element 51, 52 of the leaf spring element 3 is received. In the embodiment, the respective first fastening element respectively comprises a respective first receiving area 53, in which a respective first receiving element 51 of the leaf spring element 3 is received, whereby the leaf spring element 3 and the respective first fastening element 6 are at least indirectly connected to each other in form-fitting manner. The respective first receiving element 51 and the respective first receiving area 53 thus form a respective form-fitting connection, which can in particular be referred to as fourth form fit 55. In the embodiment, the respective second fastening element 7 further comprises a respective second receiving area 54, in which a respective second receiving element 52 of the leaf spring element 3 is received, whereby the leaf spring element 3 and the respective second fastening element 7 are at least indirectly connected to each other in form-fitting manner. Thus, the respective second receiving element 52 and the respective second receiving area 54 form a respective form-fitting connection, which can in particular be referred to as fifth form fit 56.

In the embodiment shown in FIG. 19, the leaf spring element 3 comprises at least one first leaf spring part 57 and two second leaf spring parts 58 formed separately from the first leaf spring part 57. For example, the leaf spring element 3 comprises two third leaf spring parts 59 formed separately from the leaf spring parts 57, 58. The respective first receiving element 51 is exclusively formed by the respective second leaf spring part 58, preferably related to the first and the respective second leaf spring part 57, 58 and in particular related to the respective third leaf spring part 59. The respective second receiving element 52 is exclusively formed by the respective third leaf spring part 59, preferably related to the first and the respective third leaf spring part 57, 59 and in particular related to the respective second leaf spring part 58.

As shown in FIG. 19, the leaf spring element 3 for example comprises two further leaf spring parts 60, 61, in particular formed separately from the leaf spring parts 57, 58, 59. The first leaf spring part 57 and the respective second leaf spring part 58 are at least partially, in particular completely, covered by a first one of the further leaf spring parts 60 upwards in vehicle vertical direction z. The first leaf spring part 57 and the respective third leaf spring part 59 are at least partially, in particular completely, covered by the second one of the further leaf spring parts 61 downwards in vehicle vertical direction Z. The first further leaf spring part 60 can in particular be referred to as fourth leaf spring part. The second further leaf spring part 61 can in particular be referred to as fifth leaf spring part.

As shown in FIG. 19, it is for example provided that the respective first receiving element 51 is partially formed by a respective partial area 60a of the first further leaf spring part 60. The respective first receiving element 51 is thus formed by the respective second leaf spring part 58 and the respective partial area 60a. For example, the respective second receiving element 52 is partially formed by a respective partial area 61a of the second further leaf spring part 61. Thus, the respective second receiving element 52 is partially formed by the respective third leaf spring part 52 and by the respective partial area 61a.

In the embodiment shown in FIG. 19, it is provided that the leaf spring parts 57, 58, 59 are formed fiber-reinforced, wherein fibers of the first leaf spring part 57 extend in a first direction 65 and fibers of the respective second leaf spring part 58 extend in a second direction 66 extending obliquely or perpendicularly to the first direction 65. Preferably, the fibers of the respective third leaf spring part 59 extend in the second direction 66.

The respective further leaf spring part 60, 61 is preferably formed fiber-reinforced. The fibers of the respective further leaf spring part 60, 61 preferably extend in the first direction 65.

In the embodiment shown in FIG. 20, the leaf spring element 3 comprises two local material thickenings 63 formed integrally with a base body 62 of the leaf spring element 3, by which the respective first receiving element 51 is respectively at least partially formed. In particular, the material thickenings 63 can be referred to as first material thickenings 63. In the embodiment, the leaf spring element 3 comprises two local material thickenings 64 formed integrally with the base body 62, by which the respective second receiving element 52 is respectively at least partially formed. The respective local material thickening 63, 64 is for example, in particular completely, formed by the matrix material of the leaf spring element 3.

Equivalent to the embodiment shown in FIG. 19, the respective further leaf spring element 60, 61 comprising the respective partial area 60a, 61a is also provided in the embodiment shown in FIG. 20. For example, the respective first receiving element 51 is partially formed by the respective partial area 60a. For example, the respective second receiving element 52 is partially formed by the respective partial area 61a.

### LIST OF REFERENCE CHARACTERS

1 Wheel suspension
2 spring link
2a fastening area
2b second form fit
3 leaf spring element
4 first fastening device
5 second fastening device
6 first fastening element
7 second fastening element
8 first abutment surface
9 second abutment surface
10 first bearing location
11 first bearing device
12 component
13 structure
14 first holding device
15 second holding device
16 first holding part
17 second holding part
18 first support surface
19 second support surface
20 second bearing location
21 second bearing device
22 wheel carrier
23 first screw element
24 second screw element
25 spring and/or damper device
26 receiving opening
27 connection part
27a first form fit
28 undercut
29 receiving space
30 first stop area
31 second stop area
32 eccentric screw
33 bulge
34 radius
35 second radius
36 first foil
37 second foil
38 third foil
39 fourth foil
40 manufacturing auxiliary means
41 groove structure
42 first plastic foil
43 second plastic foil
44 third plastic foil
45 fourth plastic foil
46 recess
47 bearing part
48 third form fit
49 first area
50 second area
51 first receiving element
52 second receiving element
53 first receiving area
54 second receiving area
55 fourth form fit
56 fifth form fit
57 first leaf spring part
58 second leaf spring part
59 third leaf spring part
60 further leaf spring part
60a partial area
61 further leaf spring part
61a partial area
62 base body
63 first material thickening
64 second material thickening
65 first direction
66 second direction
A first partial view
B second partial view
C top view
D partial sectional view
E section reference points
x vehicle longitudinal direction
y vehicle transverse direction
z vehicle vertical direction

1. A wheel suspension for a motor vehicle, comprising:
at least one spring link provided for guiding at least one vehicle wheel, which is formed as a leaf spring element;
at least one fastening device formed separately from the spring link, which comprises at least two fastening elements formed separately from each other, which each comprise a respective abutment surface, between which the spring link is arranged and connected to the fastening device via the abutment surfaces in force-fitting manner, which comprises at least one first bearing location, via which the spring link can be coupled to a structure of the motor vehicle in articulated manner;
at least one holding device formed separately from the spring link and the fastening device, which comprises at least two holding parts, which each comprise a respective support surface, between which the spring link is arranged and connected to the holding device via the support surfaces in force-fitting manner, which comprises at least one second bearing location, via which the spring link can be coupled to the vehicle wheel in articulated manner,
wherein the first fastening element comprises at least one receiving opening and the second fastening element comprises at least one connection part different from a screw element, which is arranged in the receiving opening for forming a form-fitting connection between the fastening elements,
wherein the holding parts are formed separately from each other and at least the support surface of one of the holding parts is connected to the spring link in form-fitting manner, and/or
wherein at least one of the respective fastening elements comprises at least one respective receiving area, in which a respective receiving element of the leaf spring element is received, whereby the leaf spring element and the respective fastening element are connected to each other in form-fitting manner.

2. The wheel suspension according to claim 1,
wherein the support surfaces at least partially delimit a receiving space formed as an undercut, in which a fastening area of the spring link is arranged for form-fitting connection of the spring link to at least one of the holding parts.

3. The wheel suspension according to claim 2,
wherein the fastening area is formed wedge-shaped.

4. The wheel suspension according to claim 1,
wherein at least one of the holding parts comprises a stop area extending obliquely or perpendicularly to its support surface, on which the spring link abuts.

5. The wheel suspension according to claim 1,
wherein at least one of the abutment surfaces comprises a bulge.

6. The wheel suspension according to claim 1,
wherein the leaf spring element comprises at least one first leaf spring part and at least one respective second leaf spring part formed separately from the first leaf spring part, wherein the respective receiving element is formed by the respective second leaf spring part.

7. The wheel suspension according to claim 6,
wherein the leaf spring parts are formed fiber-reinforced, wherein fibers of the first leaf spring part extend in a first direction and fibers of the respective second leaf spring part extend in a second direction extending obliquely or perpendicularly to the first direction.

8. The wheel suspension according to claim 1,
wherein the leaf spring element comprises at least one local respective material thickening formed integrally with a base body of the leaf spring element, by which the respective receiving element is at least partially formed.

9. The wheel suspension according to claim 1,
wherein at least one foil provided with diamond particles and/or corundum particles and/or silicon carbide particles, which is arranged between the spring link and the fastening device or the holding device.

10. The wheel suspension according to claim 9,
wherein the foil is pressed with the fastening device or the holding device.

11. The wheel suspension according to claim 9,
wherein at least one plastic foil different from the foil, which is arranged between the spring link and the fastening device or the holding device at least partially without overlap with the foil.

12. The wheel suspension according to claim 11,
wherein the foil at least partially extends in a recess of the plastic foil.

13. The wheel suspension according to claim 1,
wherein at least one bearing device is arranged at the first bearing location, via which the spring link can be coupled to the structure of the motor vehicle in articulated manner,
wherein at least one foil provided with diamond particles and/or corundum particles and/or silicon carbide particles is arranged between the bearing device and the fastening device, and/or
wherein a bearing part of the bearing device arranged at the fastening device is connected to the fastening device at least in form-fitting manner.
